(19) United States
(12) Patent Application Publication
(10) Pub. No.: US 2010/0207585 A1
(43) Pub. Date: Aug. 19, 2010

(54) RESERVING POWER FOR ELECTRONIC DEVICES

(75) Inventors: Karl J. Duvalsaint, Lagrangeville, NY (US); Moon J. Kim, Wappingers Falls, NY (US)

Correspondence Address: Keohane & D'Alessandro, 1881 Western Avenue Suite 180, Albany, NY, 12203, US

(73) Assignee: International Business Machines Corporation, Armonk, NY (US)

(21) Appl. No.: 12/388,797

(22) Filed: Feb. 19, 2009

(51) Int. Cl. H02J 7/00

(52) U.S. Cl. 320/136

(57) ABSTRACT

The present invention provides way to reserve power for electronic devices such as mobile devices. Specifically, under the present invention, a user can establish and/or change a setting/threshold corresponding to an amount of (battery) power available to the electronic device to be held in reserve. The setting can be a percentage of total available power (e.g., n %). Once set, this amount of power is held in reserve and is unavailable for use by the electronic device. Before to the total power available to the device is reduced to the amount of power set by the user (e.g., 1-n %), an alert will be issued. If the user wishes to use the power held in reserve, the user can input a previously established reserve power access code amount that will make the reserve power available to the electronic device.

### FIELD OF THE INVENTION

The present invention generally relates to electronic devices. Specifically, the present invention relates to the reserving of power for electronic devices.

### BACKGROUND OF THE INVENTION

With the rapid proliferation of electronic (e.g., mobile devices) into everyday life, power management is becoming a growing concern. Specifically, for current electronic devices (e.g., mobile devices), there is no capability for a user to designate a segment of available power to be held in reserve. Specifically, existing devices consume available power until it is exhausted and then power down. This can lead to problems when the available power is exhausted, and the user needs to use the device (e.g., for an emergency or the like).

### SUMMARY OF THE INVENTION

The present invention provides way to reserve power for electronic devices such as mobile devices. Specifically, under the present invention, a user can establish and/or change a setting/threshold corresponding to an amount of (battery) power available to the electronic device to be held in reserve. The setting can be a percentage of total available power (e.g., n %). Once set, this amount of power is held in reserve and is unavailable for use by the electronic device. Before to the total power available to the device is reduced to the amount of power set by the user (e.g., 1-n %), an alert will be issued. If the user wishes to use the power held in reserve, the user can input a previously established reserve power access code amount that will make the reserve power available to the electronic device. If the user does not input the reserve power access code within a fixed period of time from the alert or before the setting/threshold is reached, the device will be put into a sleep mode. It will remain in the sleep mode until the battery is sufficiently charged (e.g., above the setting/threshold), or until the user inputs the reserve power access code. This approach to user-controlled power management helps prevent problems that occur due to low or exhausted battery power.

A first aspect of the present invention provides a method for reserving power for an electronic device, comprising: receiving a setting corresponding to an amount of power to be held in reserve for the electronic device; maintaining the amount of power in reserve; monitoring a power consumption of the electronic device; and issuing an alert before total power available to the electronic device is reduced to the amount of power in reserve.

A second aspect of the present invention provides a system for reserving power for an electronic device, comprising: a module for receiving a setting corresponding to an amount of power to be held in reserve for the electronic device; a module for maintaining the amount of power in reserve; a module for monitoring a power consumption of the electronic device; and a module for issuing an alert before total power available to the electronic device is reduced to the amount of power in reserve.

A third aspect of the present invention provides a computer readable medium containing a program product for reserving power for an electronic device the computer readable medium comprising program code for causing the electronic device to: receive a setting corresponding to an amount of power to be held in reserve for the electronic device; maintain the amount of power in reserve; monitor a power consumption of the electronic device; and issue an alert before total power available to the electronic device is reduced to the amount of power in reserve.

A fourth aspect of the present invention provides an electronic device, comprising: a mechanism for receiving a setting corresponding to an amount of power to be held in reserve for the electronic device; a mechanism for maintaining the amount of power in reserve; a mechanism for monitoring a power consumption of the electronic device; and a mechanism for issuing an alert before total power available to the electronic device is reduced to the amount of power in reserve.

A fifth aspect of the present invention provides a method for deploying an application for reserving power for an electronic device, comprising: deploying a computer infrastructure being operable to: receiving a setting corresponding to an amount of power to be held in reserve for the electronic device; maintaining the amount of power in reserve; monitoring a power consumption of the electronic device; and issuing an alert before total power available to the electronic device is reduced to the amount of power in reserve.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an electronic device according to the prior art.

FIG. 2 depicts an electronic device having power reserve capabilities according to the present invention.

FIG. 3 depicts a method flow diagram according to the present invention.

FIG. 4 depicts a more specific computerized implementation according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following Sections:
I. General Description
II. Computerized Implementation

### I. General Description

As indicated above, the present invention provides way to reserve power for electronic devices such as mobile devices. Specifically, under the present invention, a user can establish and/or change a setting/threshold corresponding to an amount of (battery) power available to the electronic device to be held in reserve. The setting can be a percentage of total available power (e.g., n %). Once set, this amount of power is held in reserve and is unavailable for use by the electronic device. Before to the total power available to the device is reduced to the amount of power set by the user (e.g., 1-n %), an alert will be issued. If the user wishes to use the power held in reserve, the user can input a previously established input a reserve power access code amount that will make the reserve power available to the electronic device. If the user does not input the reserve power access code within a fixed period of time from the alert or before the setting/threshold is reached, the device will be put into a sleep mode. It will remain in the sleep mode until the battery is sufficiently charged (e.g., above the setting/threshold), or until the user inputs the reserve power access code. This approach to user-controlled power management helps prevent problems that occur due to low or exhausted battery power. It should be understood that although the Figures depict a cellular telephone to assist in the description of the present invention, the teachings recited herein could be used in conjunction with any type of electronic device.

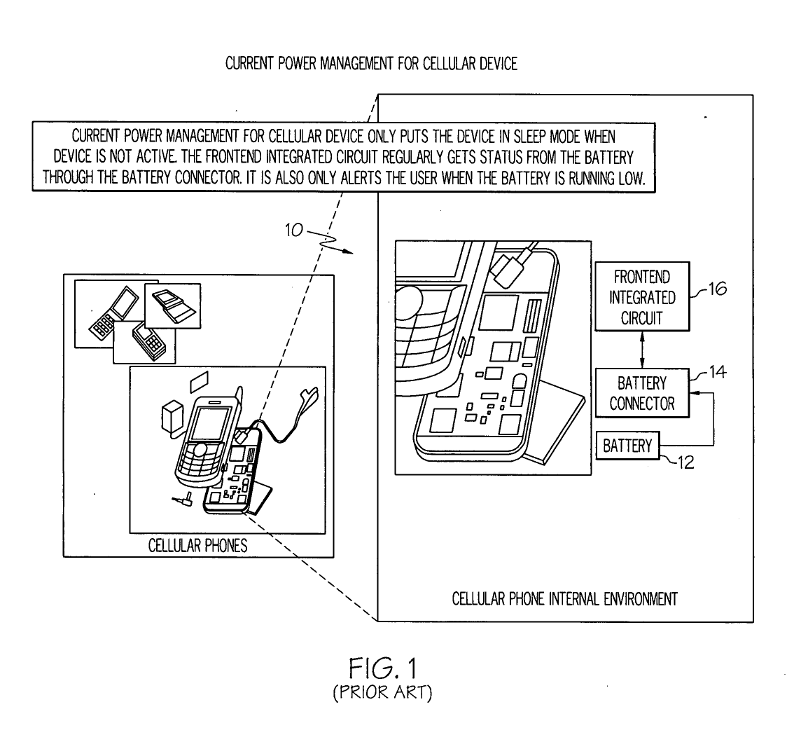

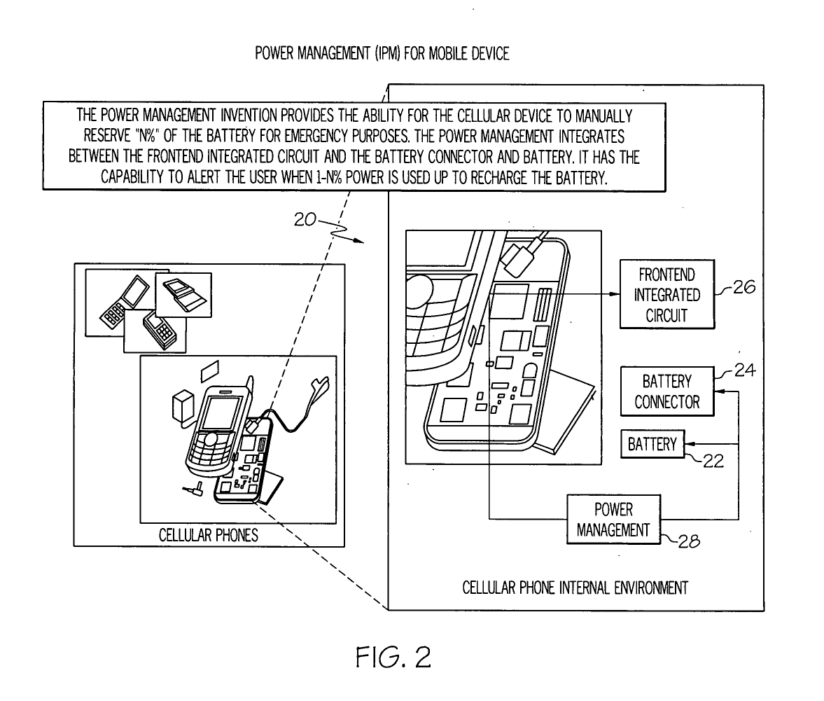

Referring to FIG. 1, a mobile device 10 according to the prior art is shown. As depicted mobile device 10 includes a battery 12, a battery connector 14, and integrated circuit 16. As depicted, there is no way for a user or the like to designate a certain amount of power to be held in reserve. The present invention addresses this deficiency. Referring to FIG. 2, a mobile device 20 in accordance with the present invention is shown. As depicted, mobile device includes (among other components) a battery 22, a battery connector 24, integrated circuit 26, and power management component 28 (which can be implemented as hardware, software, or a combination of hardware and software).

Under the present invention, power management component 28 allows a to designate: a portion (e.g., percentage) of battery power to be held in reserve; and a reserve power access code to access that reserved power should it be needed. Specifically, user will designate a portion (e.g., 10%) of mobile device 20's power (e.g., at startup), which will then be held in reserve by the system. The regular power (90%) will be used as typically known. Prior to the non-reserve power being consumed, an alert will be generated and provided (e.g., displayed, sounded, etc.) to the user. When the non-reserve power is consumed, mobile device 20 will be put into a sleep mode. However, if the user inputs the previously designated reserve power access code, the reserve power will be accessed and mobile device can continue to be used (i.e., until the reserve power is accessed). It should be noted that the reserve power access code can be input at any time (e.g., prior or after the mobile device 20 enters sleep mode). If the reserve power access code is input before, mobile device will not enter the sleep mode. The reserve power access code can be input remotely, e.g., using a landlines, a different device, etc. This allows the reserve power to be accessed without using the actual “target” electronic device (e.g., mobile device 10). For example, assume mobile device 10 is lost somewhere in the residence of its user, and its' non-reserve power is exhausted. In this case, the user could use his/her landline to input the access code and access the reserve power. The user could then call mobile device 10 to determine its location.

To be more specific, the system flow is as follows:

(1) When the mobile phone is first used. Power on→input emergency power n % (1 to 100%)→n % power save for emergency

(2) Reset reserve power→input code xxx→input reserve power n % (1 to 100%)→n % power save for emergency→save and exit.

The mobile device's system will indicate the power (excluding the emergency power) through the power indication bar. Recharge is required when the power is consumed. When the power is used up, the system will go into the sleep mode. In the sleep mode, they system will continuously used the emergency power to communicate with the cell tower. However, all other functions are not operable under this condition. In order to use the mobile device:

(3) Use selects a specific or personalized reserve power access yyy for user to allow use of the reserve power to use the device.

(4) Remote access is possible only when the reserve power access code yyy is input. Typically, the system will recognize the ringing signal is coming with the special code yyy.

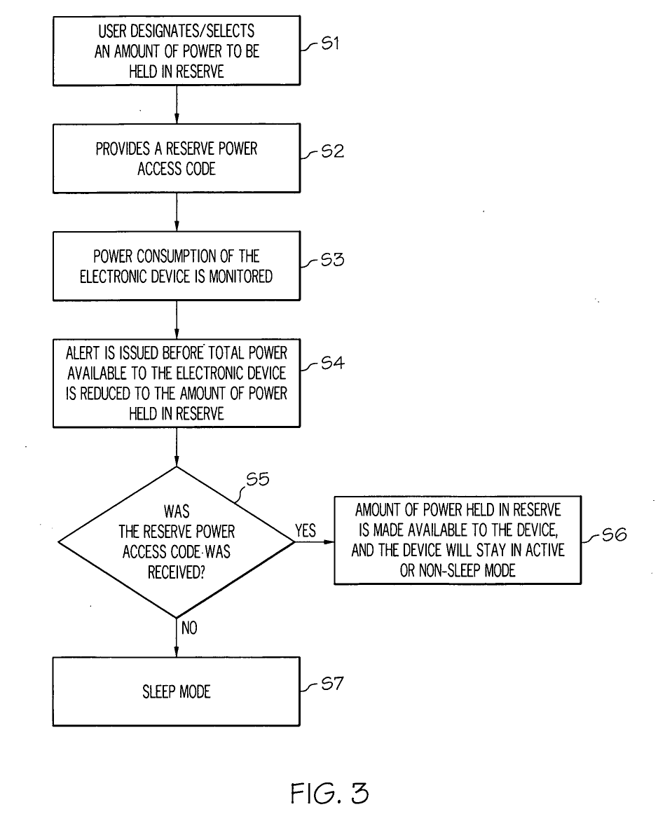

These steps are reflected in the flow diagram of FIG. 3. As depicted, in step S1, the user designates/selects an amount of power to be held in reserve. In step S2, the user provides a reserve power access code. In step S3, a power consumption of the electronic device is monitored. In step S4 an alert is issued before total power available to the electronic device is reduced to the amount of power. In step S5, it I determined whether the reserve power access code was received. If not, the device is put into a sleep mode in step S6. If the reserve power access code was received, the amount of power held in reserve is made available to the device, and the device will stay in active or non-sleep mode in step S7.

It should also be understood that the present invention could be implemented at either the mobile device level or at a server level (e.g., telecommunications provider). For example, the implementation, monitoring, management of the above outlined invention could be performed on a server or the device itself.

### II. Computerized Implementation

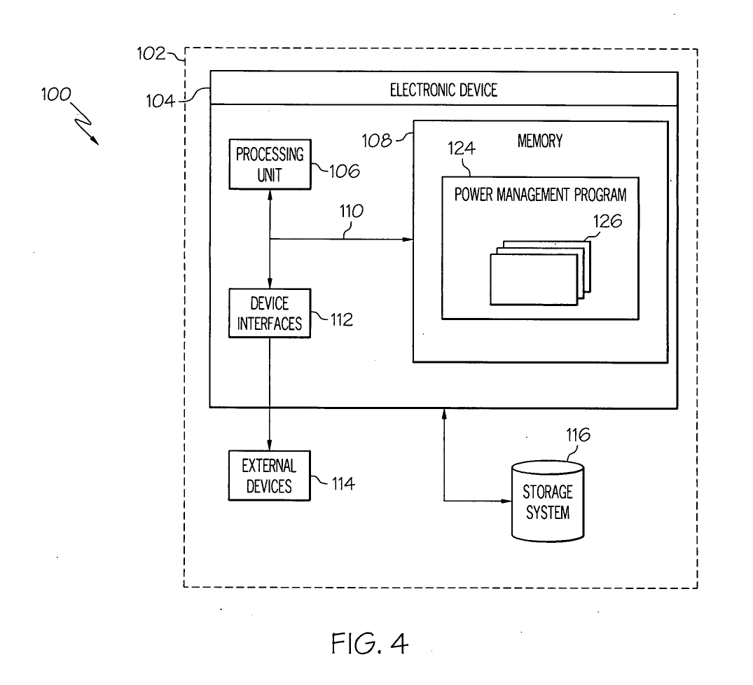

Referring now to FIG. 4, a computerized implementation 100 of the present invention is shown. As depicted, implementation 100 includes electronic device 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc. by a service provider who offers to implement, deploy, and/or perform the functions of the present invention for others.

Electronic device 104 is intended to represent any type of electronic device that may be implemented in deploying/realizing the teachings recited herein. In this particular example, electronic device 104 represents an illustrative system that could represent a mobile device such as a cellular phone, although this need not be the case. As shown, electronic device 104 includes a processing unit 106, a memory 108, a bus 110, and device interfaces 112. Further, electronic device 104 is shown communicating with one or more external devices 114 that communicate with bus via device interfaces. In general, processing unit 106 executes computer program code, such power management program 124, which is stored in memory 108 and/or storage system 116. While executing computer program code, processing unit 106 can read and/or write data to/from memory 108, storage system 116, and/or device interfaces 112. Bus 110 provides a communication link between each of the components in electronic device 104. Although not shown, electronic device 104 could also include I/O interfaces that communicate with: one or more external devices such as a kiosk, a checkout station, a keyboard, a pointing device, a display, etc.); one or more devices that enable a user to interact with electronic device 104; and/or any devices (e.g., network card, modem, etc.) that enable electronic device 104 to communicate with one or more other computing devices. Although not shown, electronic device 104 could contain multiple processing units.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the various processes of the invention. Moreover, electronic device 104 is only representative of various possible electronic devices that can include numerous combinations of hardware. To this extent, in other embodiments, electronic device 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations, e.g., on a client and server. Similarly, memory 108 and/or storage system 116 can comprise any combination of various types of data storage and/or transmission media that reside at one or more physical locations. Further, device interfaces 112 can comprise any module for exchanging information with one or more external devices. Still further, it is understood that one or more additional components (e.g., system software, math co-processing unit, etc.) not shown in FIG. 4 can be included in electronic device 104. Storage system 116 can be any type of system capable of providing storage for information under the present invention. To this extent, storage system 116 could include one or more storage devices such as magnetic disk drive or an optical disk drive. In another embodiment, storage system 116 includes data distributed across, for example, a local area network (LAN), wide area network (WAN) or a storage area network (SAN) (not shown). In addition, although not shown, additional components, such as cache memory, communication systems, system software, etc., may be incorporated into electronic device 104.

Shown in memory 108 of electronic device 104 is power management 124, which has a set of modules 126. Set of modules 126 generally provide the functions of the present invention as described herein. For example, (among other things), set of modules 26 are configured to: receive a setting corresponding to an amount of power to be held in reserve for the electronic device; maintain the amount of power in reserve; monitor a power consumption of the electronic device; issue an alert before total power available to the electronic device is reduced to the amount of power.; prevent access to the amount of power held in reserve; receive a reserve power access code; permit access to the amount of power upon receiving the reserve power access code; and/or put the electronic device into a sleep mode when the total power available to the electronic device reaches the amount of power.

While shown and described herein as way to reserve power for electronic devices, it is understood that the invention further provides various alternative embodiments. For example, in one embodiment, the invention provides a computer-readable/useable medium that includes computer program code to enable a computer infrastructure to reserve power for electronic devices. To this extent, the computer-readable/useable medium contains program code that implements each of the various processes of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 4) and/or storage system 116 (FIG. 4) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to reserve power for electronic devices. In this case, the service provider can create, maintain, support, etc., a computer infrastructure, such as computer infrastructure 102 (FIG. 4) that performs the process of the invention for one or more customers. In return, the service provider can receive payment from the customers under a subscription and/or fee agreement and/or the service provider can receive payment from the sale of advertising content to one or more third parties.

In still another embodiment, the invention provides a computer-implemented method to reserve power for electronic devices. In this case, a computer infrastructure, such as computer infrastructure 102 (FIG. 4), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as electronic device 104 (FIG. 4), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic device system/driver for a particular computing and/or device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or device devices (including, but not limited to, keyboards, displays, pointing devices, etc.) can be coupled to the system either directly or through intervening device controllers. Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for reserving power for an electronic device, comprising:
receiving a setting corresponding to an amount of power to be held in reserve for the electronic device;
maintaining the amount of power in reserve;
monitoring a power consumption of the electronic device; and
issuing an alert before total power available to the electronic device is reduced to the amount of power in reserve.

2. The method of claim 1, further comprising preventing access to the amount of power held in reserve.

3. The method of claim 2, further comprising:
receiving a reserve power access code; and
permitting access to the amount of power upon receiving the reserve power access code.

3. The method of claim 1, the reserve power access code being received remotely from the electronic device.

4. The method of claim 1, the amount of power being an amount of battery power.

5. The method of claim 1, the setting comprising a percentage of maximum power available to electronic device.

6. The method of claim 1, further comprising putting the electronic device into a sleep mode when the total power available to the electronic device reaches the amount of power.

7. A system for reserving power for an electronic device, comprising:
a module for receiving a setting corresponding to an amount of power to be held in reserve for the electronic device;
a module for maintaining the amount of power in reserve;
a module for monitoring a power consumption of the electronic device; and
a module for issuing an alert before total power available to the electronic device is reduced to the amount of power in reserve.

8. The system of claim 7, further comprising a module for preventing access to the amount of power held in reserve.

9. The system of claim 8, further comprising:
a module for receiving a reserve power access code; and
a module for permitting access to the amount of power upon receiving the reserve power access code.

10. The system of claim 7, further comprising a module for receiving remotely from the electronic device.

11. The system of claim 7, the amount of power being an amount of battery power.

12. The system of claim 7, the setting comprising a percentage of maximum power available to electronic device.

13. The system of claim 7, further comprising a module for putting the electronic device into a sleep mode when the total power available to the electronic device reaches the amount of power.

14. A computer readable medium containing a program product for reserving power for an electronic device the computer readable medium comprising program code for causing the electronic device to:
receive a setting corresponding to an amount of power to be held in reserve for the electronic device;
maintain the amount of power in reserve;
monitor a power consumption of the electronic device; and
issue an alert before total power available to the electronic device is reduced to the amount of power in reserve.

15. The computer readable medium containing the program product of claim 14, the computer readable medium further comprising program code for causing the electronic device to prevent access to the amount of power held in reserve.

16. The computer readable medium containing the program product of claim 14, the computer readable medium further comprising program code for causing the electronic device to:
receive a reserve power access code; and
permit access to the amount of power upon receiving the reserve power access code.

17. The computer readable medium containing a program product of claim 14, the electronic device being a mobile device, and the amount of power being an amount of battery power.

18. The computer readable medium containing a program product of claim 14, the setting comprising a percentage of maximum power available to electronic device.

19. The computer readable medium containing the program product of claim 14, the computer readable medium further comprising program code for causing the electronic device to put the electronic device into a sleep mode when the total power available to the electronic device reaches the amount of power.

20. An electronic device, comprising:
a mechanism for receiving a setting corresponding to an amount of power to be held in reserve for the electronic device;
a mechanism for maintaining the amount of power in reserve;
a mechanism for monitoring a power consumption of the electronic device; and
a mechanism for issuing an alert before total power available to the electronic device is reduced to the amount of power in reserve.

21. The electronic device of claim 20, further comprising:
a mechanism for preventing access to the amount of power held in reserve.
a mechanism for receiving a reserve power access code; and
a mechanism for permitting access to the amount of power upon receiving the reserve power access code.

22. A method for deploying an application for reserving power for an electronic device, comprising:
deploying a computer infrastructure being operable to:
receiving a setting corresponding to an amount of power to be held in reserve for the electronic device;
maintaining the amount of power in reserve;
monitoring a power consumption of the electronic device; and
issuing an alert before total power available to the electronic device is reduced to the amount of power in reserve.

23. The method of claim 22, the computer infrastructure being further operable to prevent access to the amount of power held in reserve.

24. The method of claim 22, the computer infrastructure being further operable to
receive a reserve power access code; and
permit access to the amount of power upon receiving the reserve power access code.

25. The method of claim 22, the computer infrastructure being further operable to: put the electronic device into a sleep mode when the total power available to the electronic device reaches the amount of power.
